(19) United States
(12) Patent Application Publication
(10) Pub. No.: US 2026/0277780 A1
(43) Pub. Date: Sep. 17, 2026

(54) AUTOMATED ERROR ANALYSIS WITHIN ISOLATED NETWORK

(71) Applicant: Lemon Inc., Grand Cayman (KY)

(72) Inventors: Suyash Singh, Wilmington, DE (US); Supapitch Kittisarakul, London (GB); Anup Vasudeo Upadhye, Wilmington, DE (US); Dmytro Biriukov, Wilmington, DE (US); Erick Escobar, Wilmington, DE (US); Dylan Nicholas Kim, Wilmington, DE (US)

(21) Appl. No.: 19/077,667

(22) Filed: Mar. 12, 2025

(51) Int. Cl. G06F 11/3668; G06F 11/3698

(52) U.S. Cl. CPC G06F 11/3692; G06F 11/3698

(57) ABSTRACT

The present disclosure involves methods, apparatus, and systems for automated failure analysis of software in an isolated environment. This can include identifying, from an error log, a set of errors generated during code execution in an isolated computing environment; parsing the set of errors to categorize each particular error into a first category of errors or a second category of errors; and for each error in the second category of errors: generating a summary of the error; identifying a portion of code causing the error; removing sensitive information from the portion of code to create masked portion of error code; and sending a message to an external system outside the isolated computing environment, the message comprising the summary and the masked portion of error code.

### TECHNICAL FIELD

The present disclosure generally relates to automated error analysis of software in an isolated network.

### BACKGROUND

Error log resolution can involve the process of analyzing and resolving errors or exceptions that occur within a software application or system. This can begin with identifying and collecting error logs from various sources, such as application servers, databases, and operating systems. These logs contain information about the nature of the error, its occurrence time, and relevant system details. Developers and system administrators then analyze these logs to pinpoint the root cause of the error, which may involve debugging, code inspection, and investigating system configurations.

### SUMMARY

The present disclosure relates to a method, system, and computer-readable storage media for automated failure analysis of software in an isolated environment. This can include identifying, from an error log, a set of errors generated during code execution in an isolated computing environment; parsing the set of errors to categorize, for each particular error, into a first category of errors or a second category of errors, wherein the first category of errors are errors that are resolvable within an isolated computing environment, and wherein the second category of errors require resolution from outside the isolated computing environment; and for each error in the second category of errors: generating a summary of the error; identifying a portion of code causing the error; removing sensitive information from the portion of code to create masked portion of error code; and sending a message to an external system outside the isolated computing environment, the message comprising the summary and the masked portion of error code.

Implementations can optionally include one or more of the following features.

In some instances, operations include for each error in the first category of errors: executing a rules engine to resolve the error.

In some instances, operations include categorizing at least one particular error into a third category of errors, wherein the third category of errors are errors that have not been previously identified; and sending a ticket to a developer within the isolated computing environment indicating the error requires resolution.

In some instances, operations include receiving a new rule from the developer; and updating the rules engine with the new rule.

In some instances, sending the message to the external system includes: performing a compliance check on the message prior to the message leaving the isolated computing environment.

In some instances, parsing the errors comprises performing a regular expression (regex) keyword search.

In some instances, the isolated computing environment is a virtual private cloud (VPC) environment.

In some instances, operations include sending the categorized errors to a user interface for display within the isolated computing environment.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for automated failure analysis of software in an isolated environment.

FIG. 2 is a flowchart illustrating an example process for automated failure analysis of software in an isolated environment.

FIG. 3 illustrates an example graphical user interface displaying failure analysis in an isolated computing environment.

FIG. 4 illustrates a schematic diagram of an example computing system.

Like reference numbers and designations in the various drawings indicate like elements.

### DETAILED DESCRIPTION

This specification relates to methods, apparatuses, and systems for automated deployment of software in an isolated computing environment or network. An isolated computing environment refers to a virtual or physical computing environment that has a logical and physical separation between the isolated computing environment and its external environment in terms of resources and physical infrastructure. The isolated computing environment and its external environment can be separated by firewalls or certain isolated, secure, or separate computing environments requires strict controls for content entering and exiting the environment. This ensures safety, privacy, and security of the content within the isolated environment. However, as new software is developed and deployed within an isolated computing environment, errors can arise that may be unique to the isolated computing environment. These errors may be resolvable within the isolated computing environment, for example, they may result from a misallocation of compute resources. In some instances, the errors may require more substantial code modification and require further development and redeployment from external to the isolated computing environment.

One example of an isolated computing environment could be an air-gapped computing environment. Air-gapping is a security measure that can involve physically isolating a computer or network from any other network, particularly the internet. This means that the air-gapped system is not connected to any other systems or networks, effectively creating a “gap” of air between it and the outside world. Air-gapping is can be used to protect highly sensitive data and critical infrastructure from cyber threats by ensuring that there is no direct electronic connection that could be exploited. Air-gapped environments provide security by being immune to remote hacking attempts and network-based attacks. This makes them ideal for handling highly sensitive data and critical operations. In air-gapped environments, data transfer is controlled and typically requires the use of physical media such as USB drives, CDs, or DVDs. Protocols can be established and followed to verify and sanitize data before it enters the isolated environment, minimizing the risk of introducing vulnerabilities. Air gapping can be employed in environments where security is paramount, such as military systems, financial institutions, critical infrastructure, and research laboratories. While air gapping can significantly enhance security, it can also introduce operational challenges, such as the need for manual data transfers and the complexity of applying updates and patches. These challenges necessitate robust procedures and tools to manage the isolated environment effectively. The proposed solution includes an automated deployment tool designed to streamline the deployment of software within air-gapped environments. This tool reduces the risk of human error, ensures that updates and patches are applied efficiently and securely, and maintains compliance with strict data transfer protocols.

This disclosure describes solutions or techniques for automatically categorizing and resolving errors occurred in the isolated computing environment. For errors that can be resolved within the isolated computing system, the described techniques can resolve them automatically, or send the errors to developers within the environment. For errors that require external assistance, an appropriate message is generated and exported from the isolated computing environment while still satisfying compliance and security requirements associated with the isolated computing environment.

The disclosed techniques can provide one or more technique advantageous. For example, in some implementations, the disclosed techniques can handle a high volume of errors, for example managing and resolving over 540,000 active tasks and 365 million monthly instances. This increases business continuity by mitigating interruptions, indirect/direct revenue loss, and user loss caused by task failures and ensuring continuous business operations. In some implementations, the disclosed techniques relieve the workload on limited personnel available to resolve failed tasks. By automating much of the communications, a streamlined process is created and can be scalable. In some implementations, the disclosed techniques overcome the dependency on specific technical knowledge such as Spark, Python and Flink by providing semi-automated summary and error analysis. In some implementations, the disclosed techniques can provide task resolution even when on-call personnel are not available and during non-working hours in a global work environment.

In some implementations, the disclosed techniques can help managing software jobs at scale and deal with a variety of errors that can disrupt operations. These include, for example, Out of Memory (OOM) errors, which occur when jobs exceed allocated memory; executor losses due to node failures or network issues; and task timeouts caused by long-running tasks. The disclosed techniques can also identify and address errors such as data skew and shuffle failures can lead to inefficiencies and job failures, while serialization/deserialization errors, file not found issues, and permission denials add layers of complexity. The disclosed techniques can also identify and address errors network failures, configuration errors, dependency issues, and checkpointing failures further complicate the landscape. The disclosed techniques can significantly improve the efficiency and reliability because addressing these errors manually is time-consuming and requires specialized technical knowledge.

In some implementations, the disclosed techniques can be a subscription-based service designed to monitor, identify, and automate the resolution of failed tasks in data processing environments. In some implementations, this can be a service that runs periodically, and auto-resolves failed tasks based on predefined custom rules, significantly reducing manual efforts and time.

The process or service can include log parsing and categorization, e.g., automatically parsing error logs (such as DORADO logs), excluding sensitive information, and summarizing task failures into concise categories. Additionally, a rules engine can be provided that applies predefined actions to resolve failed tasks (or errors) based on custom rules set by a data warehouse (DW) point of contact (POC). In some implementations, the disclosed techniques can provide a comprehensive dashboard with actionable insights, detailed failure analysis, and links to address failed tasks. Further, operational logging can be provided which captures the efficacy of the solution and provides insights for optimization. In some implementations, a messaging service can send notifications and action items to responsible team members within the isolated computing environment, or among users within and across the isolated computing environment.

In some implementations, the disclosed techniques can be implemented as a system that includes multiple layers or components, for example, log parsing service and failed task categorization layer, rules engine and failed task automation layer, failed task dashboard, operational logging and dashboarding layer, and messaging services.

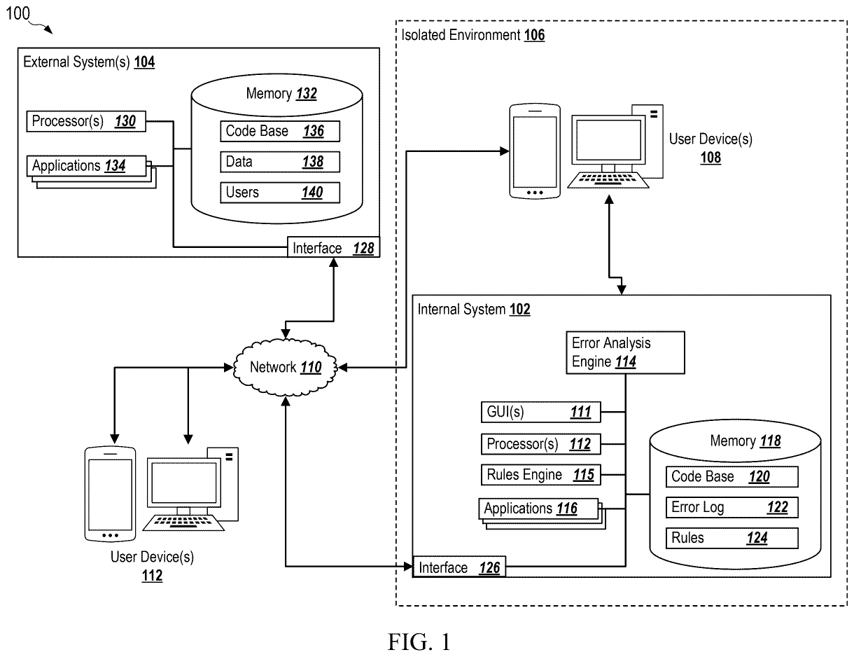

FIG. 1 illustrates a block diagram of an example system 100 for automated error analysis in an isolated network. The system 100 includes an internal system 102 that executes in an isolated environment 106, and one or more external systems 104 that communicate using a network 110. Additionally, user devices 108 and 112 internal to and external from the isolated environment 106 can interact with external system 104 and the internal system 102.

The isolated environment 106, can act as a protective firewall, or shield between the internal system 102 and the remainder of the network 110 or internet at large. In some implementations, the isolated environment 106 is a virtual private cloud (VPC). In general, the isolated environment 106 can be a virtualized system or network that provides an isolated and secure environment within a shared public network infrastructure. It can permit organizations or internal system 102 to create and manage their own virtual and/or physical network resources, such as subnets, routing tables, and network gateways, as if they were operating within a unique private data center. This level of control and isolation provides enhanced security and flexibility for businesses to deploy and manage their applications and data in the cloud according to their specific needs and compliance or regulatory requirements.

Internal system 102 can be designed to receive deployment requests from external systems 104 and deploy them within the isolated environment 106 without sacrificing the security and isolation created by the isolated environment 106. Once software is executing within the internal system 102, any errors associated with that software can be stored and analyzed within the internal system 102. Internal system 102 includes one or more processors 112, an error analysis 114, applications 116, and a memory 118.

Memory 118 can represent a single memory or multiple memories. The memory 118 can include any memory or database module and can take the form of volatile or non-volatile memory including, without limitation, magnetic media, optical media, random access memory (RAM), read-only memory (ROM), removable media, or any other suitable local or remote memory component. The memory 118 can store various objects or data, including digital asset data, public keys, user and/or account information, administrative settings, password information, caches, applications, backup data, repositories storing business and/or dynamic information, and any other appropriate information associated with the internal system 102, including any parameters, variables, algorithms, instructions, rules, constraints, or references thereto. In some implementations, memory 118 stores a code base 120, error log 122, and rules 124. Additionally, the memory 118 can store any other appropriate data, such as VPN applications, firmware logs and policies, firewall policies, a security or access log, print or other reporting files, as well as others. While illustrated within the system 100, memory 118 or any portion thereof, including some or all of the particular illustrated components, can be located remote from the internal system 102 in some instances, including as a cloud application or repository or as a separate cloud application or repository when the internal system 102 itself is a cloud-based system.

Code base 120 can be a repository of code, libraries, or other elements for running and maintaining applications 116 within the internal system 102. In some implementations, the code base 120 includes certain functions, libraries, or code that has been previously approved for execution within the isolated environment 106.

Error log 122 can represent a log of errors generated during code execution by the applications 116, code 120, or other components within internal system 102. In some implementations, the error log contains detailed exception information such as system information, stack trace, an event ID, user information associated with the error, as well as metadata (e.g., timecode, file size, etc.) related to each error.

Rules 124 can be user developed or automatically generated and are accessed by rules engine 115 to perform automated tasks or sequences of operations in order to resolve certain errors.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the internal 102. Specifically, the processor 112 executes the algorithms and operations described in the illustrated figures, as well as the various software modules and functionality, including the functionality for sending communications to and receiving transmissions from network 110, user devices 108, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the internal system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

GUI 111 of the internal system 102 interfaces with at least a portion of the system 100 for any suitable purpose, including generating a visual representation of any particular application or results and/or the content associated with any components of the user devices 108 and/or 112. In particular, the GUI 111 can be used to present results of a query or allow the developer to input queries to the internal 102, as well as to otherwise interact and present information associated with one or more applications. GUI 111 can also be used to view and interact with various web pages, applications, and web services located local or external to the internal system 102. Generally, the GUI 111 provides the user with an efficient and user-friendly presentation of data provided by or communicated within the system. The GUI 111 can include a plurality of customizable frames or views having interactive fields, pull-down lists, and buttons operated by the user. In general, the GUI 111 is often configurable, supports a combination of tables and graphs (bar, line, pie, status dials, etc.), and is able to build real time portals, application windows, and presentations. Therefore, the GUI 111 contemplates any suitable graphical user interface, such as a combination of a generic web browser, a web-enable application, intelligent engine, and command line interface (CLI) that processes information in the platform and efficiently presents the results to the user visually.

Applications 116 can be software of firmware programs that run within the isolated environment 106. Applications 116 can access the memory 118 and read/write data or perform actions, calls, and executions referencing code base 120. In some implementations, applications 116 generally are approved before deployment, and have limited capability when interacting with network 110 or external system 104. In some implementations, a specific list of approved communications or messages is provided, and any attempted message that is not on the specific list is blocked, or otherwise prevented from leaving the interface 126, and the offending application 116 can be flagged for review, uninstalled, or limited in its functionality.

Rules engine 115 can be a software system that executes a set of predefined rules 124 or to make decisions or automate actions. It operates by evaluating input data such as errors from the error log 122 and the code base 120 against the rules 124 and then executing the corresponding actions. In some implementations, the rules engine 115 can re-allocate computer resources (e.g., memory, processing power, storage space, etc.), modify code (e.g., update syntax, or re-declare variables etc.), update dependencies, or take other actions according to the rules 124 in order to resolve errors. In some implementations, the rules engine 115 can also be integrated with machine learning models to predict and prevent potential failures based on historical data and trends. Additionally, in some implementations, the rules engine 115 is used to enforce organizational policies and compliance requirements by ensuring that automated actions adhere to predefined standards and protocols.

Interface 126 can be used by the internal system 102 to communicate with other systems in a distributed environment—including within the system 100—connected to the network 110 (e.g., external systems 104, user devices 112, 108, and other systems communicably coupled to the illustrated internal system 102 and/or network 110. Generally, the interface 126 includes logic encoded in software and/or hardware in a suitable combination and operable to communicate with the network 110 and other components. More specifically, the interface 126 can include software supporting one or more communication protocols associated with communications such that the network 110 and/or interface's 126 hardware is operable to communicate physical signals within and outside of the illustrated system 100. Still further, the interface 126 can allow the internal system 102 to perform the operations described herein. In some implementations, interface 126 includes one or more firewalls or watchdog applications that monitor incoming and outgoing network traffic to ensure compliance with isolated environment 106 regulations or requirements.

Network 110 facilitates wireless or wireline communications between the components of the system 100 (e.g., between the internal system 102, the external systems 104, the user devices 108, 112, etc.), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the internal system 102, external systems 104, isolated environment 106, etc.) can be included within or deployed to network 110 or a portion thereof as one or more cloud-based services or operations. The network 110 can be all or a portion of an enterprise or secured network, while in another instance, at least a portion of the network 110 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

User devices 108 and 112 are computing devices or computers used by one or more users and developers of the software application to interact within system 100, respectively. For example, the user devices 108 can interact with the internal system 102 to review applications 116, performance data, or to approve or disapprove new deployments. In some cases, system 100 describes an enterprise computing environment, where the user devices 108 can analyze database objects (e.g., code base 120, rules 124, error log 122, etc.).

As used in the present disclosure, the term “computer” or “computing devices” is intended to encompass any suitable processing device. For example, the user devices 108 and 112 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems.

Similarly, the user devices 108 and 112 can be any system that can request data and/or interact with the internal system 102 or external systems 104. The user devices 108 and 112, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 108 and 112 can include one or more specific applications executing on the user devices 108 and 112, or the user devices 108 and 112 can include one or more Web browsers or web applications that can interact with particular applications executing remotely from the user devices 108 and 112.

The error analysis engine 114 can be responsible for resolving errors generated by new applications 116 after they are deployed into the isolated environment 106 from the external systems 104. External system 104 can be separate computing systems executing in their own isolated computing environments (not shown), or with open access to the network 110. External system 104 can include processors 130, which can be similar to processors 112, as well as a memory 132 storing a code base 136, data 138, user information 140 and other things. Applications 134, developed in external to the isolated environment 106 are in some instances required or desired to be deployed as applications 116. For example, in some instances the external systems 104 and internal system 102 are identical but operate excluded from each other because of the isolated environment 106. Once deployed within the isolated environment 106, however, certain errors may arise that were not detectable prior to deployment. For example, compute resources may be different between the isolate environment 106 and the external system 104. In some implementations, versions of dependencies may be different, network protocols may change, or other things.

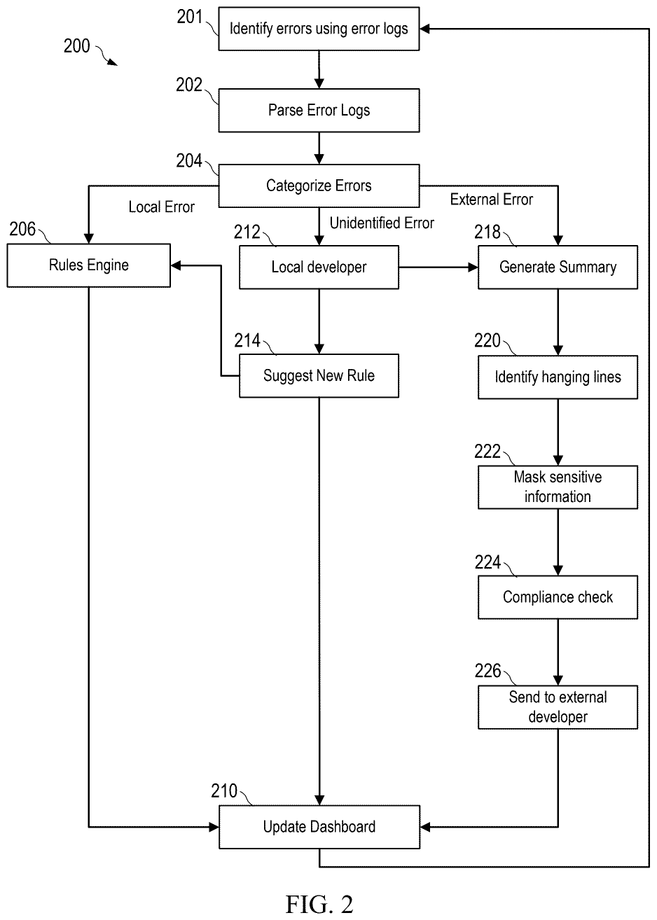

The error analysis engine 114 can include a rules engine, scripts and programming, and or one or more AI models (e.g., deep learning neural networks) that enable it to receive error logs 122, parse them into categories, including performing keyword searches or natural language processing on the error and then either resolve the error using the rules engine 115, or assigned it to the appropriate developer associated with a user device 108 or user device 112 accordingly. The operations of the error analysis engine 114 are described in more detail below with respect to FIG. 2.

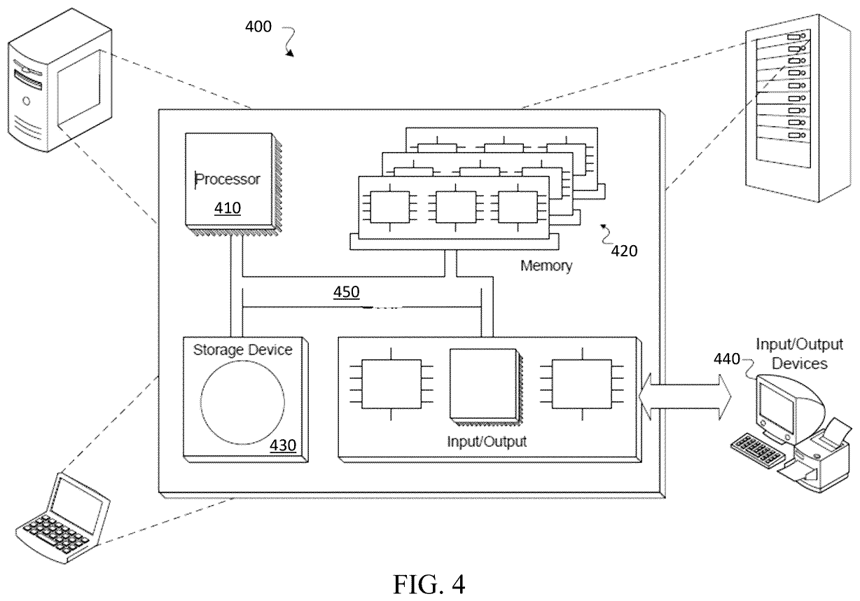

FIG. 2 is a flowchart illustrating an example process 200 for automated failure analysis of software in an isolated environment. The operations of process 200 can be performed, for example, based on the system described with respect to FIG. 1, or in another manner. The operations shown in process 200 may not be exhaustive and that other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 400 of FIG. 4, appropriately programmed, can perform the process 200. As another example, one or more computer in the example system 100 (e.g., the internal system 102), when appropriately programmed, can perform the process 200.

At 201, one or more errors are identified from an error log (e.g., error log 122 stored in memory). In some implementations this identifies a set of errors generated during code execution in the isolated computing environment. The code can include software or other type of computer programmable instructions. The error log can include a number of errors with each error including certain information pertaining to the error itself (e.g., error type, applicable program, error ID, etc.) and data pertaining to the device on which the code was executing (e.g., operating system, time/date, concurrent applications, etc.).

At 202, the error log can be parsed by the system to extract pertinent details related to each of the errors. For example, information extracted can be the application causing the error, the time of the error, other concurrently running applications or machine state when the error occurred, an error descriptor, associated lines of code, dependencies, and other information.

At 204, the errors can be categorized. In some implementations the errors are categorized into three groups. A first group representing errors that are known to be resolvable by the rules engine according to the rules (also referred to as local errors), a second group representing errors that have not been previously identified (also referred to as unidentified errors), and a third group which are known to require external support from a developer in the external system to resolve (also referred to as external errors). In some implementations, the parsed error logs are categorized using a variety of methods, including keyword searching for regular expressions (regex), tags in error metadata, or an AI analysis of the error, among other things. In some implementations, a local owner is assigned to each error based on the offending application or code.

At 206, when errors from the first category are processed by the rules engine for resolution. The rules engine can access a set of rules and perform necessary actions to resolve the error. Actions can include, but are not limited to, reallocating computing resources, modifying code (e.g., adjusting syntax, modifying variable declarations, etc.), adjusting user or application permissions, updating or installing dependencies, restarting services or dependent services or underlying infrastructure and applications, modifying configuration files or settings, applying patches or updates, clearing caches or temporary files, rolling back to a previous stable state, implementing custom error handling procedures, and sending secure notifications or alerts to relevant stakeholders of the potential repercussions. These actions collectively can ensure that errors are resolved efficiently, and that the system continues to operate smoothly. In addition to these actions, the rules engine can leverage a unique self-learning mechanism that dynamically updates its rules based on historical data and outcomes. This mechanism uses machine learning algorithms to analyze past errors and their resolutions, continuously optimizing the rules to improve future error resolution efficiency. Furthermore, the rules engine can employ predictive analytics to foresee potential failures and proactively apply corrective measures before errors occur, thereby enhancing system reliability and minimizing downtime.

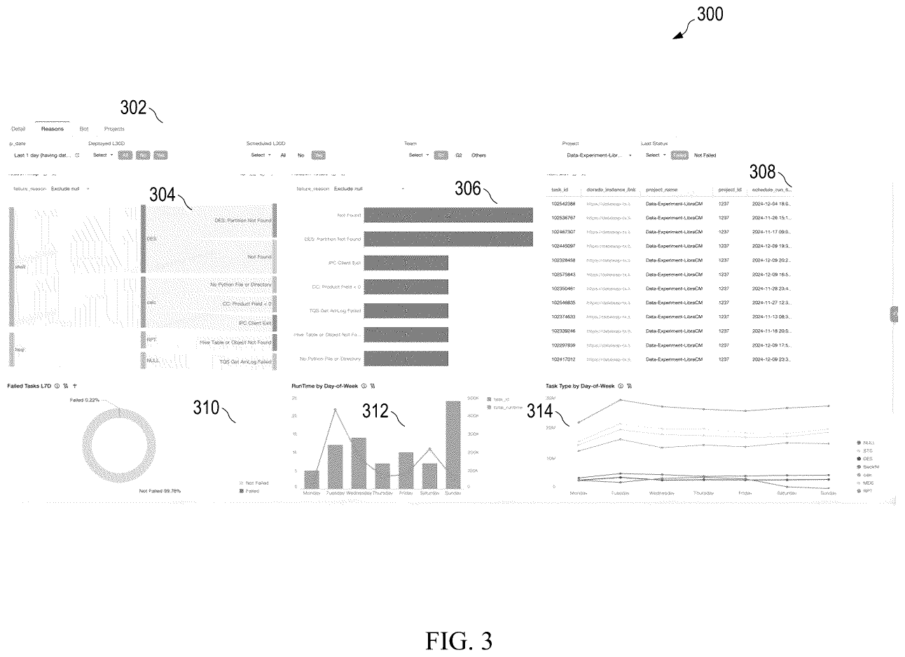

At 210, information can be sent to a graphical user interface (GUI) (e.g., a dashboard to provide updated information for display to users or developers. An example dashboard is illustrated below with respect to FIG. 3.

At 212, errors that are unable to be categorized are assigned to a local developer for resolution. In some implementations, these unidentified errors or uncategorized errors can be summarized or analyzed using one or more AI models, to provide the developer with targeted information in order to determine how best to resolve the issue. For example, a large language model can be used to summarize the offending code, and the portion of code or particular lines that are causing the error. The developer can decide whether the error can be resolved locally, or if external developer assistance is required. If external assistance is required, process 200 can proceed to 218 where a message is generated to send to the external system. If the local developer can resolve the issue, their actions or solution can be recorded.

At 214, if the local developer resolved the error, the system can suggest a new rule that includes the actions taken by the developer to resolve the error, and the conditions in which those actions should be taken. If the suggested rule is approved by a developer, it can be sent to the rules engine for future automation.

At 218, for issues requiring external assistance, a summary of the error can be generated. In some implementations, errors requiring external resolution can be errors that require more substantive code changes than the local developer is authorized to make. In some implementations, errors requiring external assistance require dependencies or dependency updates that need to be provided from outside the isolated computing environment. In some implementations, summarizing the error can involve providing the error report to a large language model, or other generative AI model, which can draft a concise, plan language summary of what is causing the error.

At 220, specific portion of the code that are causing the hang or error are identified. These can be one or more lines, function calls, or other portions of code. In some implementations, specific portions of code causing errors can be identified using advanced phrase search with natural language processing (NLP) and enhanced regex search in logs. For example, an intelligent rules engine, leveraging machine learning, can dynamically update the code or configuration to resolve issues. This approach ensures precise error resolution, minimizing software transfer out of isolated environments, enhances security, and reduces compliance-related latency, thereby maintaining business continuity effectively. Additionally, a predictive analytics layer can be built on top of this system to foresee potential failures and proactively apply corrective measures, further enhancing system reliability and operational efficiency. In some implementations, by identifying and ultimately only sending certain lines of code, the quantity of software sent out of the isolated computing environment is minimized, enhancing security and reducing latency caused by compliance requirements.

At 222, sensitive information within the portion of code is masked as a masked portion of error code. This can be personally identifiable information (PII), or specific table names, data within the tables, or other potentially sensitive information. In some implementations, an “approve” list of pre-authorized code lines is checked to confirm that the identified lines of code is suitable to be exported from the isolated computing environment. The masked portion of error code, and the generated summary can be combined to a message to be sent to an external developer of the code.

At 224, the message including the masked portion of error code and the generated summary can undergo a compliance check prior to being exported from the isolated computing environment. The compliance check can confirm that the message does not contain any sensitive or non-permitted information before it is transmitted out of the isolated computing environment. If the compliance check detects that the message contains sensitive or non-permitted information, the system can take several corrective actions such as: automatically redacting or masking the sensitive portions using algorithms, placing the message in quarantine for further review by authorized personnel, generating real-time alerts for relevant stakeholders to ensure immediate attention, logging the incident comprehensively for auditing and future reference, applying automated correction or sanitization based on predefined rules and machine learning models, escalating the issue to higher management for decision-making, and updating compliance algorithms dynamically to prevent future occurrences based on the feedback loop. This multi-layered approach can enable the secure and compliant transmission of information out of the isolated computing environment, leveraging the disclosed methods to enhance security, efficiency, and reliability.

At 226, the message is sent to the external developer. In some implementations, it is the external developer that requested the deployment of the code, or code related to the error code. In some implementations, the message includes enough details to inform the external developer of what is failing with their code in the isolated computing environment, while not revealing sensitive or private information from within the isolated computing environment.

Process 200 can return to 210, and update the dashboard. In some implementations, process 200 runs in real time, continuously, from time to time, or periodically (e.g., daily, hourly, or weekly) and each time the errors are updated in the dashboard.

FIG. 3 illustrates an example graphical user interface displaying failure analysis in an isolated computing environment. GUI 300 can include multiple panels or windows that can be user configurable, resizable, re-arrangeable, or otherwise customizable to the user's preference.

The GUI 300 can include a tool bar 302, which can have buttons, icons, drop-down menus, or other features to enable navigation within GUI 300 as well as interaction with certain elements. A categorization pane 304 illustrates a graphical breakdown of the different categories of errors pending in the error log. A bar graph pane 306 shows an illustration of the most common causes for each category. The full error stack or issue stack can be presented in a table pane 308.

In some implementations, an overview pane 310 illustrates the percentage of tasks that are completed successfully compared to the percentage that fail. A time pane 312 shows a number of errors over time (per day in the illustrated example). Time pane 314 shows the issues by type over a longer time period. These panels can assist developers with assessing the overall health of the system, as well as determining the efficacy of the error analysis engine.

FIG. 4 illustrates a schematic diagram of an example computing system 400. The system 400 can be used for the operations described in association with the implementations described herein. For example, the system 400 may be included in computing devices of the one or more online components and/or the one or more offline components. The system 400 includes a processor 410, a memory 420, a storage device 430, and an input/output device 440, which are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

1. A method comprising:
identifying, from an error log, a set of errors generated during code execution in an isolated computing environment;
parsing the set of errors to categorize, for each particular error, into a first category of errors or a second category of errors, wherein the first category of errors are errors that are resolvable within an isolated computing environment, and wherein the second category of errors require resolution from outside the isolated computing environment; and
for each error in the second category of errors:
generating a summary of the error;
identifying a portion of code causing the error;
removing sensitive information from the portion of code to create masked portion of error code; and
sending a message to an external system outside the isolated computing environment, the message comprising the summary and the masked portion of error code.

2. The method of claim 1, comprising:
for each error in the first category of errors:
executing a rules engine to resolve the error.

3. The method of claim 2 comprising:
categorizing at least one particular error into a third category of errors, wherein the third category of errors are errors that have not been previously identified; and
sending a ticket to a developer within the isolated computing environment indicating the error requires resolution.

4. The method of claim 3, comprising:
receiving a new rule from the developer; and
updating the rules engine with the new rule.

5. The method of claim 1, wherein sending the message to the external system comprises:
performing a compliance check on the message prior to the message leaving the isolated computing environment.

6. The method of claim 1, wherein parsing the errors comprises performing a regular expression (regex) keyword search.

7. The method of claim 1, wherein the isolated computing environment is a virtual private cloud (VPC) environment.

8. The method of claim 1, comprising:
sending the categorized errors to a user interface for display within the isolated computing environment.

9. One or more computer-readable storage media storing one or more instructions that, when executable by one or more computers, cause the one or more computers to perform operations comprising:
identifying, from an error log, a set of errors generated during code execution in an isolated computing environment;
parsing the set of errors to categorize, for each particular error, into a first category of errors or a second category of errors, wherein the first category of errors are errors that are resolvable within an isolated computing environment, and wherein the second category of errors require resolution from outside the isolated computing environment; and
for each error in the second category of errors:
generating a summary of the error;
identifying a portion of code causing the error;
removing sensitive information from the portion of code to create masked portion of error code; and
sending a message to an external system outside the isolated computing environment, the message comprising the summary and the masked portion of error code.

10. The computer-readable storage media of claim 9, the operations comprising:
for each error in the first category of errors:
executing a rules engine to resolve the error.

11. The computer-readable storage media of claim 10, the operations comprising:
categorizing at least one particular error into a third category of errors, wherein the third category of errors are errors that have not been previously identified; and
sending a ticket to a developer within the isolated computing environment indicating the error requires resolution.

12. The computer-readable storage media of claim 11, the operations comprising:
receiving a new rule from the developer; and
updating the rules engine with the new rule.

13. The computer-readable storage media of claim 9, wherein sending the message to the external system comprises:
performing a compliance check on the message prior to the message leaving the isolated computing environment.

14. The computer-readable storage media of claim 9, wherein parsing the errors comprises performing a regular expression (regex) keyword search.

15. The computer-readable storage media of claim 9, wherein the isolated computing environment is a virtual private cloud (VPC) environment.

16. The computer-readable storage media of claim 9, the operations comprising:
sending the categorized errors to a user interface for display within the isolated computing environment.

17. A computer-implemented system, comprising:
one or more computers; and
one or more computer memory devices interoperably coupled with the one or more computers and having computer-readable storage media storing one or more instructions that, when executed by the one or more computers, perform one or more operations comprising:
identifying, from an error log, a set of errors generated during code execution in an isolated computing environment;
parsing the set of errors to categorize, for each particular error, into a first category of errors or a second category of errors, wherein the first category of errors are errors that are resolvable within an isolated computing environment, and wherein the second category of errors require resolution from outside the isolated computing environment; and
for each error in the second category of errors:
generating a summary of the error;
identifying a portion of code causing the error;
removing sensitive information from the portion of code to create masked portion of error code; and
sending a message to an external system outside the isolated computing environment, the message comprising the summary and the masked portion of error code.

18. The system of claim 17, the operations comprising:
for each error in the first category of errors:
executing a rules engine to resolve the error.

19. The system of claim 18, the operations comprising:
categorizing at least one particular error into a third category of errors, wherein the third category of errors are errors that have not been previously identified; and
sending a ticket to a developer within the isolated computing environment indicating the error requires resolution.

20. The system of claim 19, the operations comprising:
receiving a new rule from the developer; and
updating the rules engine with the new rule.
